(19) United States
(12) Patent Application Publication
(10) Pub. No.: US 2023/0214740 A1
(43) Pub. Date: Jul. 6, 2023

(54) DIGITAL CONSTRUCTION-BASED INTELLIGENT CONSTRUCTION PERIOD EARLY WARNING SYSTEM AND METHOD

(71) Applicant: CHINA CONSTRUCTION INDUSTRIAL & ENERGY ENGINEERING GROUP CO.,LTD., Nanjing (CN)

(72) Inventors: Liang Wang, Nanjing (CN); Huangdong Wang, Nanjing (CN); Shaohua Wang, Nanjing (CN); Man Feng, Nanjing (CN); Jiadong Zhu, Nanjing (CN); Jia He, Nanjing (CN); Jun Yan, Nanjing (CN); Xiaoling Liu, Nanjing (CN); Xun Zhuo, Nanjing (CN); Gangzi Ding, Nanjing (CN); Fuyang Jia, Nanjing (CN); Jinhao Liang, Nanjing (CN)

(73) Assignee: CHINA CONSTRUCTION INDUSTRIAL & ENERGY ENGINEERING GROUP CO.,LTD., Nanjing (CN)

(21) Appl. No.: 18/119,825

(22) Filed: Mar. 10, 2023

(30) Foreign Application Priority Data
Nov. 21, 2022 (CN) 202211455187.5

(51) Int. Cl. G06Q 10/0631; G06N 5/01

(52) U.S. Cl. CPC G06Q 10/063114; G06N 5/01

(57) ABSTRACT

The present disclosure discloses a digital construction-based intelligent construction period early warning system and method, which belongs to the technical field of intelligent early warning. The system includes a digital construction module, a data calling module, an initial judgment module, an association analysis module, and an adjustment early warning module. An output end of the digital fabrication module is connected to an input end of the data calling module; an output end of the data calling module is connected to an input end of the initial judgment module; an output end of the initial judgment module is connected to an input end of the association analysis module; and an output end of the association analysis module is connected to an input end of the adjustment early warning module.

### TECHNICAL FIELD

The present disclosure relates to the field of intelligent early warning technologies, and in particular, to a digital construction-based intelligent construction period early warning system and method.

### BACKGROUND

Digitalization of engineering industry is mainly reflected in four aspects: management digitalization, business digitalization, tool intelligence, and digital business. The management digitalization is now commonly referred to as management informatization. Centering on construction period management, management informatization is realized on the basis of standardization. After quantitative management of a future construction period is implemented, informatization will transit to stages of digitalization and intelligence. The service digitalization centers on engineering products, implements digital simulation of the engineering products, and implements interconnection with physical engineering. A main implementation tool is Building Information Modeling (BIM). The tool intelligence is to implement intelligence of partial operation tools of engineering industry by means of digitization, such as intelligent design software in a design stage, intelligent construction equipment in a construction stage, and an intelligent assembly factory. The digital business includes BIM consulting, special construction/transformation of intelligent engineering, informatization services, intelligent tool services, digital software and hardware products, and the like. For the engineering industry, the first two are the core and basic content of current digitalization development.

The driving force of management digitalization is mainly the need of the management of an enterprise. Huger and huger project engineering, finer and finer management requirements, the needs of resource integration and platform construction, and the need of risk control all require refinement, quantification, digitalization, and intelligence of project management.

At present, as a management tool for digital construction, an intelligent construction site can improve project management capability, and implement interconnection between the digitalization and an engineering entity relying on the Internet of Things technology in the engineering industry. However, there is insufficient technical support for specific details therein, for examples, many aspects of construction period judgment, treatment, early warning, and the like.

### SUMMARY

An objective of the present disclosure is to provide a digital construction-based intelligent construction period early warning system and method to solve the problems proposed in the above-mentioned BACKGROUND.

In order to solve the above-mentioned technical problems, the present disclosure provides the following technical solution that: a digital construction-based intelligent construction period early warning method includes the following steps:
S1, acquiring a new section in a digital construction period, the section referring to an individual project in a digital construction period project (that is, construction engineering capable of being independent relatively in individual engineering, and engineering that has an independent design document, that cannot exert production capacity or engineering benefits independently after completion, and that forms part of the individual engineering), and acquiring a feature factor of a new section;
S2, acquiring a construction period project process under historical data, constructing a data association model between the new section and an overdue node, and generating a predicted quantity of overdue nodes under the new section;
S3, generating a feature association model between the new section and a deleted section according to the construction period project process under the historical data, and generating a predicted deleted section under the new section; and
S4, adjusting the generated predicted quantity of overdue nodes according to the generated predicted deleted section, outputting a final predicted quantity of overdue nodes, setting an overdue node threshold value range, and generating early warning information to an administrator port in a case that the final predicted quantity of overdue nodes exceeds the set overdue node threshold value range.

According to the above-mentioned technical solution, the constructing a data association model between the new section and an overdue node includes:
acquiring the feature factor of the new section, the feature factor including test, evaluation, and acceptance, where
the overdue node includes a mild overdue node (also commonly referred to as a first-level overdue node) and a severe overdue node (an overdue node except the first-level overdue node), a system is set with an overdue time threshold value, a node which does not exceed the overdue time threshold value is marked as the mild overdue node, a node which exceeds the overdue time threshold value is marked as the severe overdue node, and
a plurality of overdue nodes are set to meet the requirement of prioritizing in daily use, so as to further effectively control a construction period;
S2-1, acquiring the construction period project process under the historical data as a training data set D, where
$$\text{D} = \left\{\left({\text{A}}_{1} , {\text{y}}_{1}\right) , \left({\text{A}}_{2} , {\text{y}}_{2}\right) , ⋯ , \left({\text{A}}_{\text{N}} , {\text{y}}_{\text{N}}\right)\right\}$$
A₁, A₂, ... , A_{N} respectively represent construction period project processes under the historical data; y₁, y₂, . . . , y_{N} respectively represent corresponding quantities of overdue nodes;
any construction period project process is marked as Aᵢ, Aᵢ={x₁, x₂, ... , xₐ}, x₁, x₂, ... , xₐ respectively represent new sections, and there is not less than one feature factor in any new section;
S2-2, in input space where the training data set is located, recursively dividing each area into two sub-areas and determining an output value on each sub-area to construct a binary decision tree:
$${min}_{\text{j, s}} \left[{min}_{{\text{c}}_{1}} {\sum }_{{\text{x}}_{\text{i}} ∈ {\text{R}}_{1} \left(\text{j, s}\right)} {\left({\text{y}}_{\text{i}} - {\text{c}}_{1}\right)}^{2} + {min}_{{\text{c}}_{2}} {\sum }_{{\text{x}}_{\text{i}} ∈ {\text{R}}_{2} \left(\text{j, s}\right)} {\left({\text{y}}_{\text{i}} - {\text{c}}_{2}\right)}^{2}\right]$$
where j represents an optimal segmentation variable, s represents a cut-off point; R₁ and R₂ represent two divided sub-areas, c₁ and c₂ respectively represent sample output mean values corresponding to the two sub-areas divided at a current node, and xᵢ and yᵢ respectively represent an input and an output of the current node;
calculating and outputting the optimal segmentation variable and the cut-off point, dividing the present node data set into two leaf nodes according to the optimal segmentation variable and the cut-off point, and distributing the training data set into the two leaf nodes;
S2-3, repeating S2-2 for the generated two leaf nodes, setting a minimum sample quantity in the node as H, ending an operation in a case that there is a sample quantity less than H in either of the generated leaf nodes, and taking a mean value of the current leaf node as a predicted output result; and
S2-4, acquiring the new section and the feature factor of the new section in the digital construction period, substituting into the model, and taking the finally output mean value of the leaf node as a predicted value of a quantity of overdue nodes.

In the above-mentioned technical solution, the quantity of overdue nodes is analyzed by the decision tree, and the following operations are recursively performed on each node to construct the binary decision tree from a root node according to the training data set; and the training data set of the node is set as D, and a Gini index of an existing feature on the data set is calculated. A feature with the minimum Gini index and a corresponding cut-off point are selected as an optimal segmentation variable and an optimal cut-off point from all possible features A and their possible cut-off points a. Two sub-nodes are generated from the existing node according to the optimal segmentation variable and the optimal cut-off point, and the training data set is distributed into the two sub-nodes.

According to the above-mentioned technical solution, the feature association model between the new section and the deleted section includes:
acquiring an association time length between the new section and the deleted section in the construction period project process under the historical data, where
the association time length refers to the time length between the deleted section and the closest new section, and the new section is before the deleted section;
acquiring an association factor between the new section and the deleted section in the construction period project process under the historical data, where
the association factor includes full inclusion and partial inclusion, the full inclusion refers to that the feature factors of all new sections before the deleted section include all feature factors of the deleted section, and the partial inclusion refers to that the feature factors of all new sections before the deleted section include partial feature factors of the deleted section;
constructing the feature association model:
$$\text{Q} = \frac{1}{2} \left[{\text{k}}_{1} ∗ \left|{\text{T}}_{0} - {\text{T}}_{\text{q}}\right| + {\text{k}}_{2} ∗ {\text{E}}_{0}\right]$$
where Q represents a feature association value of a section; T₀ represents a mean value of the association time length between the new section and the deleted section of the construction period project process under the historical data; T_{q} represents an interval time length between the current section and the closest new section; k₁ represents a time length influence coefficient value; E₀ represents a proportional value of the association factor under the historical data, and the proportional value refers to the proportion of the deleted section in a case that there is an association factor in historical data summarization; k₂ represents an association factor influence coefficient value, and takes 0 or 1; and the association factor influence coefficient value is 1 when there is a feature factor associated with the new section, and the association factor influence coefficient value is 0 when there is no feature factor associated with the new section.

In the above-mentioned technical solution, fitting is performed in combination with the historical data, and whether each section can become a deleted section is analyzed. For example, the new section has a feature factor such as “test” or “acceptance”, and then related feature of the “test” or the “acceptance” cannot appear again within a period of time. Because this is not practical, the original “test” will become a deleted section. Whether the original “test” will become the deleted section, an interval time length between the new section and the deleted section also has great “discourse power”, so comprehensive analysis needs to be performed. In this application, the weight is divided directly by half.

According to the above-mentioned technical solution, the adjusting the generated predicted quantity of overdue nodes according to the generated predicted deleted section includes:
setting an association threshold value Qmax, and calculating a feature association value of each section; in a case that there is a feature association value exceeds the association threshold value Qmax, marking the section as a predicted deleted section, and outputting the predicted deleted section to the administrator port;
fitting a linear relationship between a quantity of deleted sections and the quantity of overdue nodes by using historical data, where the quantity of overdue nodes decreases as the quantity of deleted sections increases; outputting a loss value of the predicted quantity of overdue nodes according to the quantity of deleted sections, where specific calculation is as follows:
$$\text{K} = {\text{K}}_{\text{t}} - {\text{U}}_{\text{t}} ∗ {\text{v}}_{1}$$
where Kₜ represents a predicted value of the quantity of overdue nodes; Uₜ represents a predicted quantity of deleted sections; v₁ represents an influence coefficient; K represents a final predicted quantity of overdue nodes, and K rounds up; and
setting an overdue node threshold value range, and generating early warning information to the administrator port in a case that the final predicted quantity of overdue nodes exceeds the set overdue node threshold value range.

A digital construction-based intelligent construction period early warning system includes a digital construction module, a data calling module, an initial judgment module, an association analysis module, and an adjustment early warning module.

The digital construction module is configured to input data into the system according to a construction period plan, generate a digital construction period, simultaneously continuously collect and acquire new sections in the digital construction period, and acquire a feature factor of the new section, the section referring to an individual project in a digital construction period project; the data calling module is configured to call a construction period project process under historical data; the initial judgment module is configured to generate a data association model between the new section and an overdue node according to the called historical data, and generate a predicted quantity of overdue nodes under the new section; the association analysis module is configured to generate a feature association model between the new section and the deleted section according to the construction period project process under the historical data, and generate a predicted deleted section under the new section; and the adjustment early warning module is configured to adjust a generated predicted quantity of overdue nodes according to the generated predicted deleted section, output a final predicted quantity of overdue nodes, set an overdue node threshold value range, and generate early warning information to an administrator port in a case that the final predicted quantity of overdue nodes exceeds the set overdue node threshold value range.

An output end of the digital fabrication module is connected to an input end of the data calling module; an output end of the data calling module is connected to an input end of the initial judgment module; an output end of the initial judgment module is connected to an input end of the association analysis module; and an output end of the association analysis module is connected to an input end of the adjustment early warning module.

According to the above-mentioned technical solution, the digital construction module includes a construction period construction unit and a factor acquisition unit.

The construction period construction unit is configured to input data into the system according to the construction period plan, and generate a digital construction period; and the factor acquisition unit is configured to continuously collect and acquire new sections in the digital construction period, and acquire feature factors of the new sections.

An output end of the construction period construction unit is connected to an input end of the factor acquisition unit.

According to the above-mentioned technical solution, the data calling module includes a data storage unit and a data calling unit.

The data storage unit is configured to store a digital construction period project process of a historical project; and the data calling unit is configured to call data content stored in the data storage unit.

An output end of the data storage unit is connected to an input end of the data calling unit.

According to the above-mentioned technical solution, the initial judgment module includes a data association unit and a prediction unit.

The data association unit is configured to construct a data association model between the new section and an overdue node according to the called historical data; and the predicted unit is configured to generate a predicted quantity of overdue nodes under the new section based on the data association unit.

An output end of the data association unit is connected to an input end of the prediction unit.

According to the above-mentioned technical solution, the association analysis module includes a feature association unit and a data analysis unit.

The feature association unit is configured to generate a feature association model between the new section and the deleted section according to the construction period project process under the historical data; and the data analysis unit generates a predicted deleted section under the new section based on the feature association model.

An output end of the feature association unit is connected to an input end of the data analysis unit.

According to the above-mentioned technical solution, the adjustment early warning module includes an adjustment unit and an early warning unit.

The adjustment unit is configured to adjust the generated predicted quantity of overdue nodes according to the generated predicted deleted section, and output the final predicted quantity of overdue nodes; and the early warning unit is configured to set the overdue node threshold value range, and generate early warning information to the administrator port in a case that the final predicted quantity of overdue nodes exceeds the set overdue node threshold value range.

An output end of the adjustment unit is connected to an input end of the early warning unit.

Compared with the prior art, the present disclosure achieves the beneficial effects that:

by the present disclosure, the digital construction module is configured to collect and acquire new sections in the digital construction period, acquire feature factors of the new section, simultaneously call the construction period project process under historical data to construct the data association model between the new section and the overdue node, and generate the predicted quantity of overdue nodes under the new section and the predicted deleted section under the new section; the adjustment early warning module is configured to adjust a generated predicted quantity of overdue nodes according to the generated predicted deleted section, output the final predicted quantity of overdue nodes, set the overdue node threshold value range, and generate early warning information to the administrator port in a case that the final predicted quantity of overdue nodes exceeds the set overdue node threshold value range; and the present disclosure can identify the association influence caused by the new section under the digital construction period, and output the predicted quantity of overdue nodes, so as to realize intelligent early warning and reduce the probability of false alarm.

### BRIEF DESCRIPTION OF THE DRAWINGS

The accompanying drawings are used to provide further understanding of the present disclosure, constitute a part of the description, and are used for explaining the present disclosure together with the embodiments of the present disclosure, but do not constitute a limitation to the present disclosure. In the drawings:

FIG. 1 is a schematic diagram of a new section of a digital construction-based intelligent construction period early warning system and method of the present disclosure.

FIG. 2 is a schematic flowchart of the digital construction-based intelligent construction period early warning system and method of the present disclosure.

### DETAILED DESCRIPTION OF THE EMBODIMENTS

Technical solutions in the embodiments of the present disclosure will be clearly and completely described below with reference to the drawings in the embodiments of the present disclosure. Apparently, the described embodiments are merely part rather than all of the embodiments of the present disclosure. On the basis of the embodiments of the present disclosure, all other embodiments obtained by those of ordinary skill in the art without creative work fall within the scope of protection of the present disclosure.

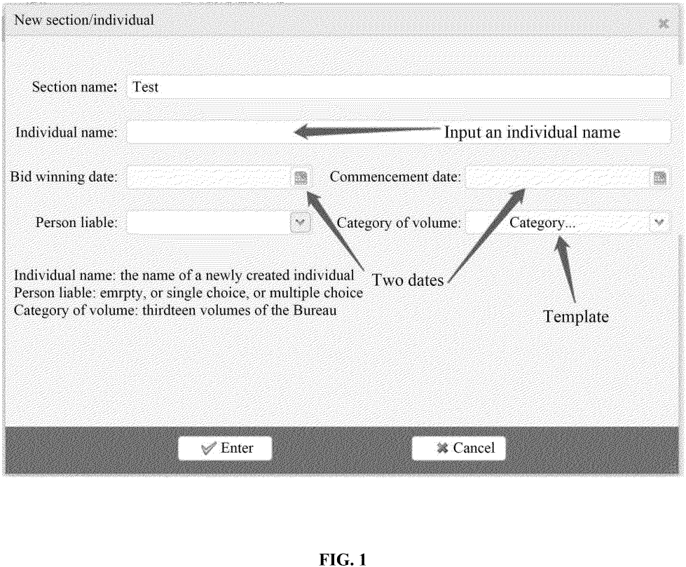

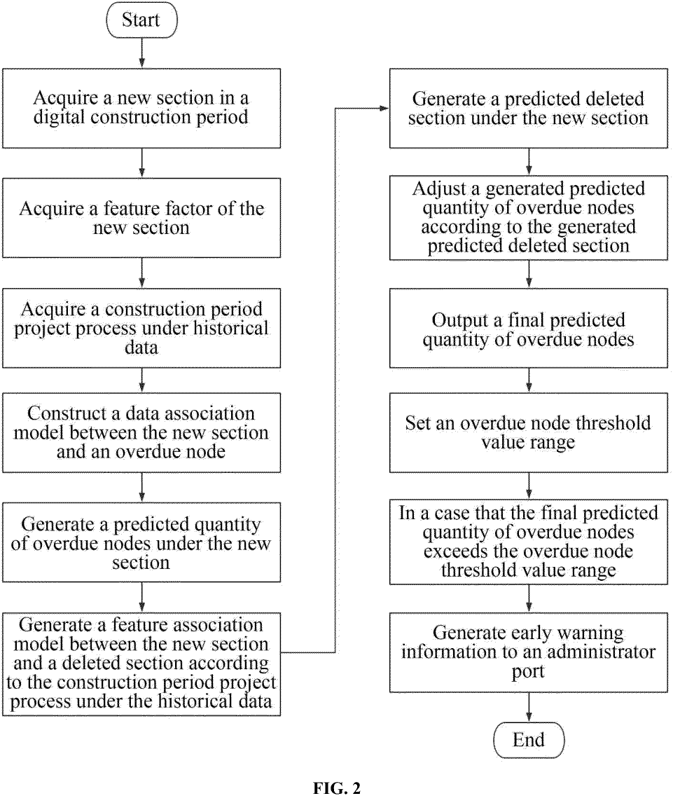

Reference is made to FIG. 1 to FIG. 2, in Embodiment 1:
a construction period project process under historical data is acquired, a data association model between the new section and an overdue node is constructed, and a predicted quantity of overdue nodes under the new section is generated; a feature association model between the new section and the deleted section is generated, and a predicted deleted section under the new section is generated;
a feature factor of the new section is acquired, and the feature factor including test, evaluation, and acceptance;
S2-1, the construction period project process under the historical data is acquired as a training data set D;
$$\text{D} = \left\{\left({\text{A}}_{1} , {\text{y}}_{1}\right) , \left({\text{A}}_{2} , {\text{y}}_{2}\right) , ⋯ , \left({\text{A}}_{\text{N}} , {\text{y}}_{\text{N}}\right)\right\}$$
where, A₁, A₂, ... , A_{N} respectively represent construction period project processes under the historical data; y₁, y₂, . . . , y_{N} respectively represent corresponding quantities of overdue nodes;
any construction period project process is marked as Aᵢ, Aᵢ={x₁, x₂, ... , xₐ}, x₁, x₂, ... , xₐ respectively represent new sections, and there is not less than one feature factor in any new section;
S2-2, in input space where the training data set is located, each area is recursively divided into two sub-areas and an output value on each sub-area is determined to construct a binary decision tree:
$${min}_{\text{j, s}} \left[{min}_{{\text{c}}_{1}} {\sum }_{{\text{x}}_{\text{i}} ∈ {\text{R}}_{1} \left(\text{j, s}\right)} {\left({\text{y}}_{\text{i}} - {\text{c}}_{1}\right)}^{2} + {min}_{{\text{c}}_{2}} {\sum }_{{\text{x}}_{\text{i}} ∈ {\text{R}}_{2} \left(\text{j, s}\right)} {\left({\text{y}}_{\text{i}} - {\text{c}}_{2}\right)}^{2}\right]$$
where j represents an optimal segmentation variable; s represents a cut-off point; R₁ and R₂ represent two divided sub-areas; c₁ and c₂ respectively represent sample output mean values corresponding to the two sub-areas divided at a current node; xᵢ and yᵢ respectively represent an input and an output of the current node;
the optimal segmentation variable and the cut-off point are calculated and output, and the present node data set is divided into two leaf nodes according to the optimal segmentation variable and the cut-off point, and the training data set is distributed into the two leaf nodes;
S2-3, S2-2 is repeated for the generated two leaf nodes, a minimum sample quantity in the node is set as H, an operation is ended in a case that there is a sample quantity less than H in either of the generated leaf nodes, and a mean value of the current leaf node is taken as a predicted output result; and
S2-4, the new section and the feature factor of the new section in the digital construction period are acquired and are substituted into the model, and the finally output mean value of the leaf node is taken as a predicted value of a quantity of overdue nodes.

According to the above-mentioned historical data, the process of the whole project is specifically included. For example, certain historical data may include the content: a new section at a certain time point has the feature of “test”; after the new section, at a certain time point, an original section is deleted, and the feature is “test”; and whether there is content such as an overdue node.

The feature association model between the new section and the deleted section includes:
acquiring an association time length between the new section and the deleted section in the construction period project process under the historical data, where
the association time length refers to the time length between the deleted section and the closest new section, and the new section is before the deleted section;
acquiring an association factor between the new section and the deleted section in the construction period project process under the historical data, where
the association factor includes full inclusion and partial inclusion, the full inclusion refers to that the feature factors of all new sections before the deleted section include all feature factors of the deleted section, and the partial inclusion refers to that the feature factors of all new sections before the deleted section include partial feature factors of the deleted section.

The full inclusion or partial inclusion are that, for example, a certain deleted section includes “test” and “evaluation”, and then whether all the new sections before include the above-mentioned two features is determined. If both features are included, then it is determined as full inclusion. If neither of the features is included, then the feature factor belongs to an irrelevant factor, and a subsequent influence factor is 0. If one of the features is included, then it is judged as partial inclusion.

The feature association model is constructed:

$$\text{Q} = \frac{1}{2} \left[{\text{k}}_{1} ∗ \left|{\text{T}}_{0} - {\text{T}}_{\text{q}}\right| + {\text{k}}_{2} ∗ {\text{E}}_{0}\right]$$

Where Q represents a feature association value of a section; T₀ represents a mean value of the association time length between the new section and the deleted section of the construction period project process under the historical data; T_{q} represents an interval time length between the current section and the closest new section; k₁ represents a time length influence coefficient value; E₀ represents a proportional value of the association factor under the historical data, and the proportional value refers to the proportion of the deleted section in a case that there is an association factor in historical data summarization; k₂ represents an association factor influence coefficient value, and takes 0 or 1; and the association factor influence coefficient value is 1 when there is a feature factor associated with the new section, and the association factor influence coefficient value is 0 when there is no feature factor associated with the new section.

The step of adjusting the generated predicted quantity of overdue nodes according to the generated predicted deleted section includes:
an association threshold value Qmax is set, and a feature association value of each section is calculated; in a case that there is a feature association value exceeds the association threshold value Qmax, the section is marked as a predicted deleted section, and the predicted deleted section is output to the administrator port;
a linear relationship between a quantity of deleted sections and the quantity of overdue nodes is fit by using historical data, and the quantity of overdue nodes decreases as the quantity of deleted sections increases; a loss value of the predicted quantity of overdue nodes is output according to the quantity of deleted sections; specific calculation is as follows:

$${\text{K = K}}_{\text{t}} - {\text{U}}_{\text{t}} * {\text{v}}_{\text{1}}$$

Where Kₜ represents a predicted value of the quantity of overdue nodes; Uₜ represents a predicted quantity of deleted sections; v₁ represents an influence coefficient; K represents a final predicted quantity of overdue nodes, and K rounds up.

An overdue node threshold value range is set, and early warning information is generated to the administrator port in a case that the final predicted quantity of overdue nodes exceeds the set overdue node threshold value range.

In Embodiment 2, a digital construction-based intelligent construction period early warning system is provided. The system includes a digital construction module, a data calling module, an initial judgment module, an association analysis module, and an adjustment early warning module.

The digital construction module is configured to input data into the system according to a construction period plan, generate a digital construction period, simultaneously continuously collect and acquire new sections in the digital construction period, and acquire feature factors of the new sections, the section referring to an individual project in a digital construction period project; the data calling module is configured to call a construction period project process under historical data; the initial judgment module is configured to generate a data association model between the new section and an overdue node according to the called historical data, and generate a predicted quantity of overdue nodes under the new section; the association analysis module is configured to generate a feature association model between the new section and the deleted section according to the construction period project process under the historical data, and generate a predicted deleted section under the new section; and the adjustment early warning module is configured to adjust a generated predicted quantity of overdue nodes according to the generated predicted deleted section, output a final predicted quantity of overdue nodes, set an overdue node threshold value range, and generate early warning information to an administrator port in a case that the final predicted quantity of overdue nodes exceeds the set overdue node threshold value range.

An output end of the digital fabrication module is connected to an input end of the data calling module; an output end of the data calling module is connected to an input end of the initial judgment module; an output end of the initial judgment module is connected to an input end of the association analysis module; and an output end of the association analysis module is connected to an input end of the adjustment early warning module.

The digital construction module includes a construction period construction unit and a factor acquisition unit.

The construction period construction unit is configured to input data into the system according to a construction period plan, and generate a digital construction period; and the factor acquisition unit is configured to continuously collect and acquire new sections in the digital construction period, and acquire feature factors of the new sections.

An output end of the construction period construction unit is connected to an input end of the factor acquisition unit.

The data calling module includes a data storage unit and a data calling unit.

The data storage unit is configured to store a digital construction period project process of a historical project; and the data calling unit is configured to call data content stored in the data storage unit.

An output end of the data storage unit is connected to an input end of the data calling unit.

The initial judgment module includes a data association unit and a prediction unit.

The data association unit is configured to construct a data association model between the new section and an overdue node according to the called historical data; and the predicted unit is configured to generate a predicted quantity of overdue nodes under the new section based on the data association unit.

An output end of the data association unit is connected to an input end of the prediction unit.

The association analysis module includes a feature association unit and a data analysis unit.

The feature association unit is configured to generate a feature association model between the new section and the deleted section according to the construction period project process under the historical data; and the data analysis unit generates a predicted deleted section under the new section based on the feature association model.

An output end of the feature association unit is connected to an input end of the data analysis unit.

The adjustment early warning module includes an adjustment unit and an early warning unit.

The adjustment unit is configured to adjust the generated predicted quantity of overdue nodes according to the generated predicted deleted section, and output the final predicted quantity of overdue nodes; and the early warning unit is configured to set the overdue node threshold value range, and generate the early warning information to the administrator port in a case that the final predicted quantity of overdue nodes exceeds the set overdue node threshold value range.

An output end of the adjustment unit is connected to an input end of the early warning unit.

It should be noted that in this specification, relational terms such as first and second are only used to distinguish one entity or operation from another, and do not necessarily require or imply that any actual relationship or sequence exists between these entities or operations. Moreover, the terms “include” and “comprise”, or any of their variants are intended to cover a non-exclusive inclusion, so that a process, method, article, or device that includes a list of elements not only includes those elements but also includes other elements that are not expressly listed, or further includes elements inherent to such process, method, article, or device.

Finally, it is to be noted that: the above is only preferred embodiments of the present disclosure, but is not intended to limit the present disclosure. Although the present disclosure has been described in detail with reference to the above-mentioned embodiments, for those skilled in the art, they may still modify the technical solutions recorded in several of the above-mentioned embodiments, or make equivalent replacement for some technical features therein. Any modification, equivalent replacement, or improvement made without departing from the spirit and principle of the invention shall fall within the protection scope of the invention.

What is claimed is:

1. A digital construction-based intelligent construction period early warning method, comprising the following steps:
S1, acquiring a new section in a digital construction period, the section referring to an individual project in a digital construction period project, and acquiring a feature factor of the new section;
S2, acquiring a construction period project process under historical data, constructing a data association model between the new section and an overdue node, and generating a predicted quantity of overdue nodes under the new section;
S3, generating a feature association model between the new section and a deleted section according to the construction period project process under the historical data, and generating a predicted deleted section under the new section;
S4, adjusting the generated predicted quantity of overdue nodes according to the generated predicted deleted section, outputting a final predicted quantity of overdue nodes, setting an overdue node threshold value range, and generating early warning information to an administrator port in a case that the final predicted quantity of overdue nodes exceeds the set overdue node threshold value range;
the constructing a data association model between the new section and an overdue node comprises:
acquiring the feature factor of the new section, the feature factor comprising test, evaluation, and acceptance;
S2-1, acquiring the construction period project process under the historical data as a training data set D;
$$\text{D} = \left\{\left({\text{A}}_{1} , {\text{y}}_{1}\right) , \left({\text{A}}_{2} , {\text{y}}_{2}\right) , ⋯ , \left({\text{A}}_{\text{N}} , {\text{y}}_{\text{N}}\right)\right\}$$
wherein A₁, A₂, ···, A_{N} respectively represent construction period project processes under the historical data; y₁, y₂, ···, y_{N} respectively represent corresponding quantities of overdue nodes;
any construction period project process is marked as Aᵢ, Aᵢ={x₁, x₂, ···, xₐ}, x₁, x₂, ···, xₐ respectively represent new sections, and there is not less than one feature factor in any new section;
S2-2, in input space where the training data set is located, recursively dividing each area into two sub-areas and determining an output value on each sub-area to construct a binary decision tree:
$${min}_{\text{j, s}} \left[{min}_{{\text{c}}_{1}} {\sum }_{{\text{x}}_{\text{i}} ∈ {\text{R}}_{1} \left(\text{j, s}\right)} {\left({\text{y}}_{\text{i}} - {\text{c}}_{1}\right)}^{2} + {min}_{{\text{c}}_{2}} {\sum }_{{\text{x}}_{\text{i}} ∈ {\text{R}}_{1} \left(\text{j, s}\right)} {\left({\text{y}}_{\text{i}} - {\text{c}}_{2}\right)}^{2}\right]$$
wherein j represents an optimal segmentation variable; s represents a cut-off point; R₁ and R₂ represent two divided sub-areas; c₁ and c₂ respectively represent sample output mean values corresponding to the two sub-areas divided at a current node; xᵢ and yᵢ respectively represent an input and an output of the current node;
calculating and outputting the optimal segmentation variable and the cut-off point, dividing the present node data set into two leaf nodes according to the optimal segmentation variable and the cut-off point, and distributing the training data set into the two leaf nodes;
S2-3, repeating S2-2 for the generated two leaf nodes, setting a minimum sample quantity in the node as H, ending an operation in a case that there is a sample quantity less than H in either of the generated leaf nodes, and taking a mean value of the current leaf node as a predicted output result;
S2-4, acquiring the new section and the feature factor of the new section in the digital construction period, substituting into the model, and taking the finally output mean value of the leaf node as a predicted value of a quantity of overdue nodes;
the feature association model between the new section and the deleted section comprises:
acquiring an association time length between the new section and the deleted section in the construction period project process under the historical data, wherein
the association time length refers to the time length between the deleted section and the closest new section, and the new section is before the deleted section;
acquiring an association factor between the new section and the deleted section in the construction period project process under the historical data, wherein
the association factor comprises full inclusion and partial inclusion, the full inclusion refers to that the feature factors of all new sections before the deleted section comprises all feature factors of the deleted section, and the partial inclusion refers to that the feature factors of all new sections before the deleted section comprises partial feature factors of the deleted section;
constructing the feature association model:
$$\text{Q} = \frac{1}{2} \left[{\text{k}}_{1} ∗ \left|{\text{T}}_{0} - {\text{T}}_{\text{q}}\right| + {\text{k}}_{2} ∗ {\text{E}}_{0}\right]$$
wherein Q represents a feature association value of a section; T₀ represents a mean value of the association time length between the new section and the deleted section of the construction period project process under the historical data; T_{q} represents an interval time length between the current section and the closest new section; k₁ represents a time length influence coefficient value; E₀ represents a proportional value of the association factor under the historical data, and the proportional value refers to the proportion of the deleted section in a case that there is an association factor in historical data summarization; k₂ represents an association factor influence coefficient value, and takes 0 or 1; and the association factor influence coefficient value is 1 when there is a feature factor associated with the new section, and the association factor influence coefficient value is 0 when there is no feature factor associated with the new section.

2. The digital construction-based intelligent construction period early warning method according to claim 1, wherein the adjusting the generated predicted quantity of overdue nodes according to the generated predicted deleted section comprises:
setting an association threshold value Qmax, and calculating a feature association value of each section; in a case that there is a feature association value exceeds the association threshold value Qmax, marking the section as a predicted deleted section, and outputting the predicted deleted section to the administrator port;
fitting a linear relationship between a quantity of deleted sections and the quantity of overdue nodes by using historical data, wherein the quantity of overdue nodes decreases as the quantity of deleted sections increases; outputting a loss value of the predicted quantity of overdue nodes according to the quantity of deleted sections, wherein specific calculation is as follows:
$$\text{K} = {\text{K}}_{\text{t}} - {\text{U}}_{\text{t}} ∗ {\text{v}}_{1}$$
wherein Kₜ represents a predicted value of the quantity of overdue nodes; Uₜ represents a predicted quantity of deleted sections; v₁ represents an influence coefficient; K represents a final predicted quantity of overdue nodes, and K rounds up; and
setting an overdue node threshold value range, and generating early warning information to the administrator port in a case that the final predicted quantity of overdue nodes exceeds the set overdue node threshold value range.

3. A digital construction-based intelligent construction period early warning system using the digital construction-based intelligent construction period early warning method according to claim 1, comprising a digital construction module, a data calling module, an initial judgment module, an association analysis module, and an adjustment early warning module, wherein
the digital construction module is configured to input data into the system according to a construction period plan, generate a digital construction period, simultaneously continuously collect and acquire new sections in the digital construction period, and acquire feature factors of the new sections, the section referring to an individual project in a digital construction period project; the data calling module is configured to call a construction period project process under historical data; the initial judgment module is configured to generate a data association model between the new section and an overdue node according to the called historical data, and generate a predicted quantity of overdue nodes under the new section; the association analysis module is configured to generate a feature association model between the new section and the deleted section according to the construction period project process under the historical data, and generate a predicted deleted section under the new section; and the adjustment early warning module is configured to adjust a generated predicted quantity of overdue nodes according to the generated predicted deleted section, output a final predicted quantity of overdue nodes, set an overdue node threshold value range, and generate early warning information to an administrator port in a case that the final predicted quantity of overdue nodes exceeds the set overdue node threshold value range;
an output end of the digital fabrication module is connected to an input end of the data calling module; an output end of the data calling module is connected to an input end of the initial judgment module; an output end of the initial judgment module is connected to an input end of the association analysis module; and an output end of the association analysis module is connected to an input end of the adjustment early warning module.

4. The digital construction-based intelligent construction period early warning system according to claim 3, wherein the digital construction module comprises a construction period construction unit and a factor acquisition unit;
the construction period construction unit is configured to input data into the system according to the construction period plan, and generate a digital construction period; the factor acquisition unit is configured to continuously collect and acquire new sections in the digital construction period, and acquire feature factors of the new sections; and
an output end of the construction period construction unit is connected to an input end of the factor acquisition unit.

5. The digital construction-based intelligent construction period early warning system according to claim 3, wherein the data calling module comprises a data storage unit and a data calling unit;
the data storage unit is configured to store a digital construction period project process of a historical project; the data calling unit is configured to call data content stored in the data storage unit; and
an output end of the data storage unit is connected to an input end of the data calling unit.

6. The digital construction-based intelligent construction period early warning system according to claim 3, wherein the initial judgment module comprises a data association unit and a prediction unit;
the data association unit is configured to construct a data association model between the new section and an overdue node according to the called historical data; the predicted unit is configured to generate a predicted quantity of overdue nodes under the new section based on the data association unit; and
an output end of the data association unit is connected to an input end of the prediction unit.

7. The digital construction-based intelligent construction period early warning system according to claim 3, wherein the association analysis module comprises a feature association unit and a data analysis unit;
the feature association unit is configured to generate a feature association model between the new section and the deleted section according to the construction period project process under the historical data; the data analysis unit generates a predicted deleted section under the new section based on the feature association model; and
an output end of the feature association unit is connected to an input end of the data analysis unit.

8. The digital construction-based intelligent construction period early warning system according to claim 3, wherein the adjustment early warning module comprises an adjustment unit and an early warning unit;
the adjustment unit is configured to adjust the generated predicted quantity of overdue nodes according to the generated predicted deleted section, and output the final predicted quantity of overdue nodes; the early warning unit is configured to set the overdue node threshold value range, and generate the early warning information to the administrator port in a case that the final predicted quantity of overdue nodes exceeds the set overdue node threshold value range; and
an output end of the adjustment unit is connected to an input end of the early warning unit.
